(19) United States
(12) Patent Application Publication
(10) Pub. No.: US 2011/0314482 A1
(43) Pub. Date: Dec. 22, 2011

(54) SYSTEM FOR UNIVERSAL MOBILE DATA

(75) Inventors: Shiraz Cupala, Seattle, WA (US); Kevin Geisner, Mercer Island, WA (US); John Clavin, Seattle, WA (US); Kenneth A. Lobb, Sammamish, WA (US); Brian Ostergren, Redmond, WA (US)

(73) Assignee: MICROSOFT CORPORATION, Redmond, WA (US)

(21) Appl. No.: 12/819,115

(22) Filed: Jun. 18, 2010

(51) Int. Cl. G06F 9/54

(52) U.S. Cl. 719/328

(57) ABSTRACT

A system and method is disclosed aggregating and organizing a user's cloud data in an encompassing system, and then exposing the sum-total of that cloud data to application programs via a common API. Such a system provides rich presence information allowing users to map and unify the totality of their experiences across all of their computing devices, as well as discovering other users and their experiences. In this way, users can enhance their knowledge of, and interaction with, their own environment, as well as open up new social experiences with others.

### BACKGROUND

The current trend in computing is away from mainframe systems toward cloud computing. Cloud computing is Internet-based computing, whereby shared resources such as software and other information are provided to a variety of computing devices on-demand via the Internet. It represents a new consumption and delivery model for IT services where resources are available to all network-capable devices, as opposed to older models where resources were stored locally across the devices. Cloud computing typically involves the provision of dynamically scalable and often virtualized resources as a service over the Internet. The move toward cloud computing opens up a new potential for mobile and other networked devices to work in conjunction with each other to provide greater interaction and a much richer experience with respect to third party and a user's own resources.

With the push toward cloud computing, there is a need for a new model for data aggregation and dissemination. The current model employs a number of disjointed application programming interfaces (APIs) to allow access to the sum-total of a user's cloud data. There is no coherent or comprehensive system for organizing and providing access to all of a user's cloud data. The result is disjointed interaction and overlooked user experiences with respect to their multiple computing devices and the computing devices of others.

### SUMMARY

The technology, briefly described, comprises a system and method for aggregating and organizing a user's cloud data in an encompassing system, and then exposing the sum-total of that cloud data to application programs via a common API. Such a system provides rich presence information allowing users to map and unify the totality of their experiences across all of their computing devices, as well as discovering other users and their experiences. In this way, users can enhance their knowledge of, and interaction with, their own environment, as well as open up new social experiences with others.

In embodiments, user data relating to a wide range of aspects of a user's life may be detected by their computing devices and aggregated in a data store. The data may then be processed, for example by categorizing the data into data classes, summarizing the data within each class and synthesizing the data by drawing inferences from specific items of data to create new items of data. Thereafter, a generalized API may be used to expose the full range of a user's data in the data store, across all data classes and for all device types, to an application program.

In one example, the present technology relates to a method of organizing and allowing access to cloud data. The method includes the steps of: a) detecting data of a user via one or more computing devices, the detected data including at least one of a location of the user and an activity of the user; b) aggregating the data detected in said step a) in a data store; and c) exposing the data aggregated in the data store in said step b) to an application program via a common application programming interface.

In a further example, the present technology relates to a computer-readable storage medium for programming a processor to perform a method of organizing and allowing access to cloud data. The method includes the steps of: a) detecting data of a user via one or more computing devices, the detected data including at least one of: a1) a location of the user, a2) an activity of the user, a3) a profile of the user, and a4) devices owned by the user; b) aggregating the data detected in said step a) in a data store, the location data being stored in a first data class, the activity data being stored in a second data class, the profile data being stored in a third data class and the device data being stored in a fourth data class; c) summarizing the data in each of the first, second, third and fourth data classes to arrive at at least one representative item of data for each of the first, second, third and fourth data classes; and d) exposing the data aggregated in the data store in said step b) to an application program via a common application programming interface.

In another example, the present technology relates to a method of organizing and allowing access to cloud data, the method comprising: a) detecting data of a user via one or more computing devices relating at least to where a user is and what a user is doing; b) aggregating the data detected in said step a) in a data store; c) defining a trigger event, the trigger event relating to occurrence of a condition measured by the one or more computing devices; d) determining whether data indicating that the trigger event has occurred is aggregated to the data store; and e) exposing the data aggregated in the data store in said step b) to an application program via a single application programming interface upon a determination in said step d) that data indicating that the trigger event has occurred has been aggregated to the data store.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a first system in which the technology discussed herein may be utilized.

FIG. 2 depicts a second system in which the technology discussed herein may be utilized.

FIG. 3 is a block diagram of a data store in accordance with the present technology.

FIG. 4 is a flowchart illustrating a first method for uploading data to the data store.

FIG. 5 is a flowchart illustrating a second method for uploading data to the data store.

FIG. 6 is a flowchart illustrating a method for organizing and storing data in the data store.

FIG. 7 is a flowchart illustrating a first method for accessing data in the data store.

FIG. 8 is a flowchart illustrating a second method for accessing data in the data store.

FIG. 9 is an illustration of a mobile device with an alert provided by the technology discussed herein.

FIG. 10 is an illustration of a display device with media selected by the technology discussed herein.

FIG. 11 is a block diagram of an exemplary computing environment.

FIG. 12 is a block diagram of an exemplary gaming console.

FIG. 13 is a block diagram of an exemplary mobile device.

### DETAILED DESCRIPTION

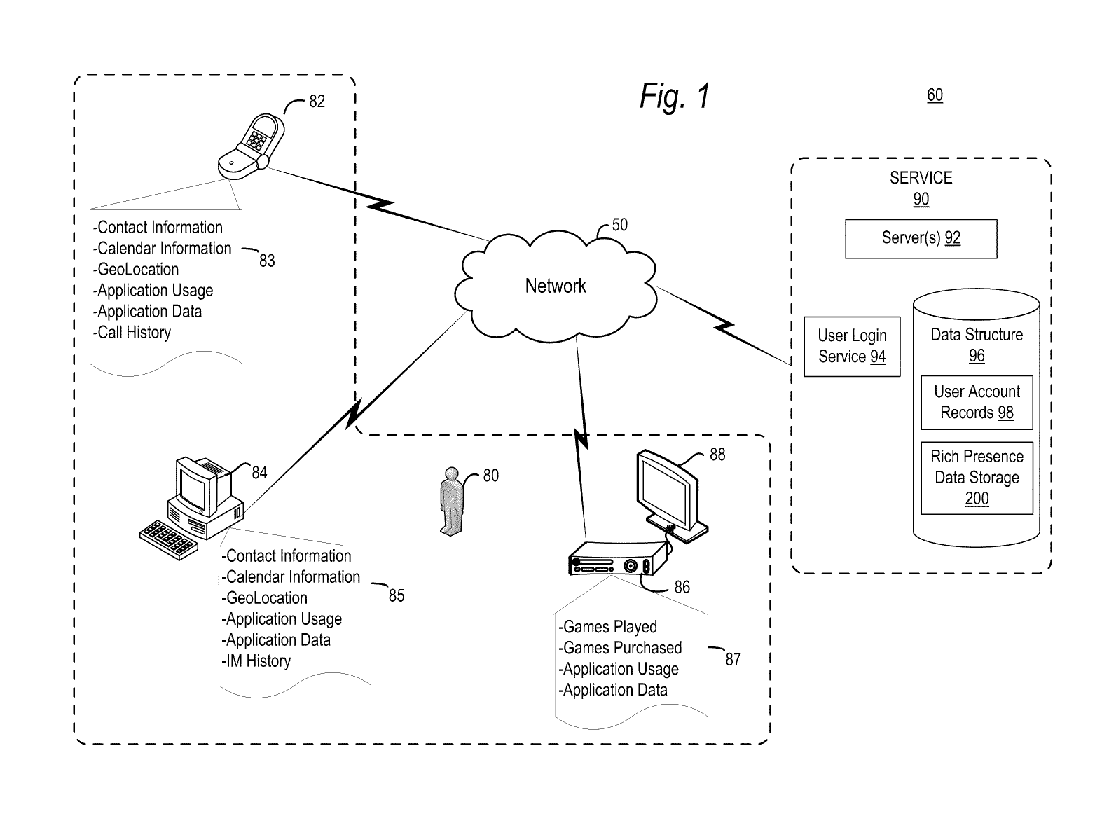

Embodiments of the present technology will now be described with reference to FIGS. 1 through 13, which in general relate to a system for aggregating and organizing all of a user's cloud data in an encompassing system, and then exposing the sum-total of that cloud data to application programs via a common API. Such a system provides rich presence information allowing users to map and unify the totality of their experiences across all of their computing devices, as well as discovering other users and their experiences. In this way, users can enhance their knowledge of, and interaction with, their own environment, as well as open up new social experiences with others.

In accordance with the present technology, data from all aspects of a user's life and experiences, both past and present, may be uploaded to a data store. The data may be stored in different classes, where related types of data may be stored in the same class. The data may be processed in a variety of ways, including for example summarizing the data of a given class and tagging the data in different classes to aid in its use across multiple computing devices and applications. Additionally, data may be synthesized and cross-referenced against other data to infer additional data which may then be stored in one or more classes.

Unlike conventional systems, the present technology (i.e., the inventive technology of this application) provides a general API which exposes and allows access to the sum-total of a user's stored data, as well as the stored data of other users. Thus, a user is able to access rich presence data, providing a comprehensive view, across all of a user's devices, of where a user is and what they are doing for past, present (real time) and future time periods. As the same data may be available for a user's friends and others, a user may also gain access in real time to their friends' experiences to open up new social opportunities and discovery. Personal privacy settings allow a user to set opt-in permissions and different access settings. These principals and others of the present technology are explained below in greater detail.

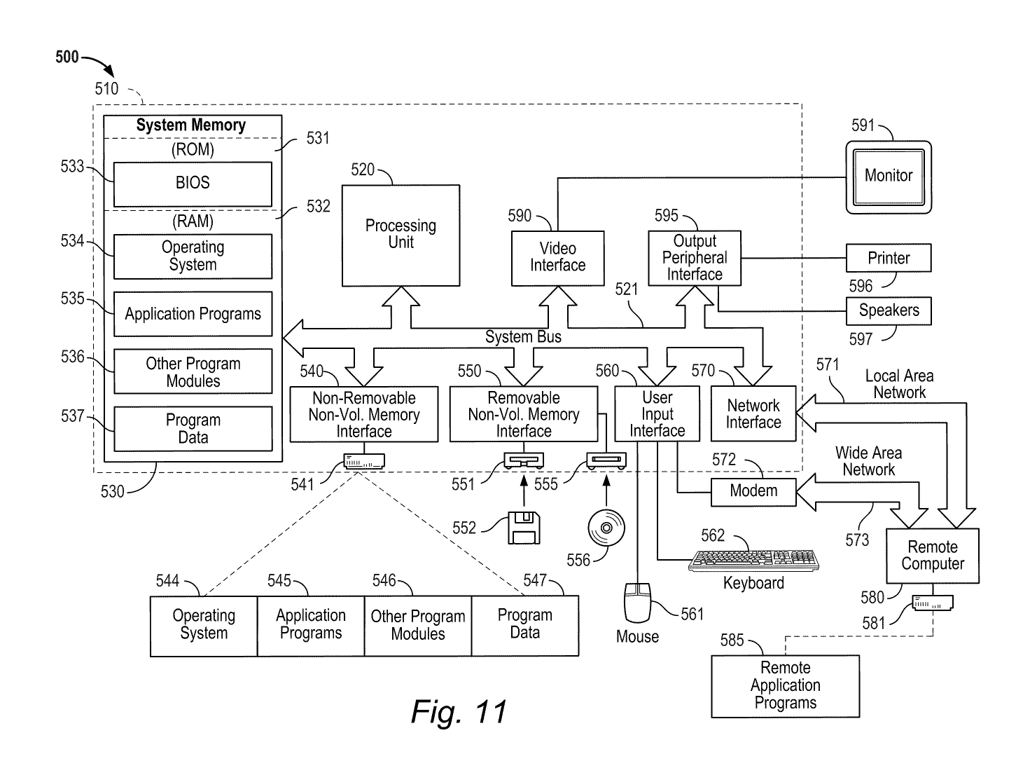

FIG. 1 shows a block diagram of a sample network topology 60 for implementing the present technology. Network topology 60 includes a plurality of computing devices 82, 84, 86 belonging to a single user 80. In one example, computing device 82 may be a mobile telephone of a mobile telephone network, computing device 84 may be a personal computer such as a desktop computer, laptop computer or tablet, and computing device 86 may be a set-top box or game console having an associated display 88. The computing devices 82, 84, 86 may also be connected to a service 90 via network 50. Example embodiments of these computing devices are set forth below with respect to FIGS. 11, 12 and 13.

Each of the various types of computing devices may store their data locally and “in the cloud,” for example on a rich presence storage location 200 in service 90 as explained below. Each device may have the same data, different data or different versions of the same data. As an example, mobile device 82 may include information 83 having data such as contact information, calendar information, geo location information, application usage data, application specific data, and a user's messaging and call history. The personal computing device 84 may include information 85 having data such as contact information, calendar information, geo location information, application usage, application data, and message history for an associated user 80. Gaming console 86 may include information 87 such as a history of games played, a history of games purchased, a history of which applications are played most by user 80, and application data, such as achievements, awards, and recorded sessions.

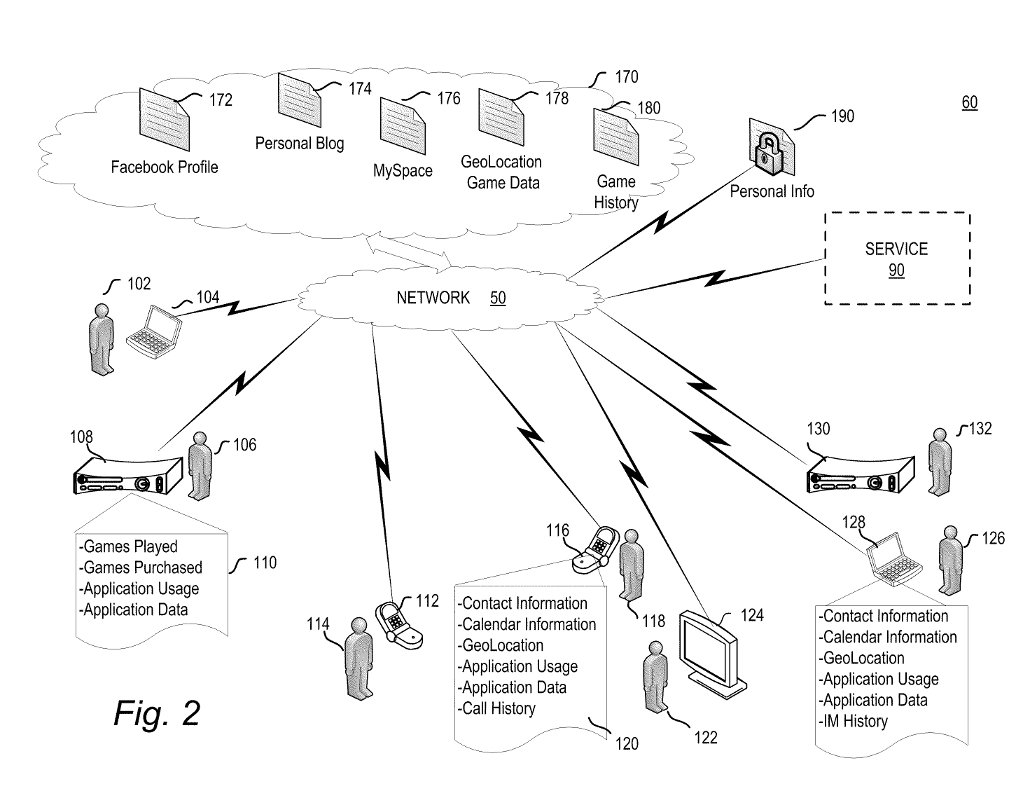

In addition to a real world social interaction, users can engage in virtual social interactions. For example, user 80 may engage in an online game with other users (such as those shown in FIG. 2). In the game, the users may interact not only by playing the game, but also by verbal or messaging communications between them.

The computing devices 82, 84, 86 shown in FIG. 1 are by way of example only and one or more of these may be omitted in further embodiments. Moreover, the user 80 may have a variety of other computing devices, or additional replicas of the computing devices 82, 84, 86, in further embodiments. Such computing devices may in general include, but are not limited to, desktop computers, laptop computers, tablets, cellular telephones, televisions/set top boxes, video game consoles, automobiles, cameras and smart appliances. Other computing devices are contemplated.

The service 90 may for example be a large scale Internet service provider such as for example MSN® services and Xbox LIVE, though it need not be in further embodiments. Service 90 may have one or more servers 92, which may for example include a database management service 218 as explained below. Server(s) 92 may further include a web server, a game server supporting gaming applications, a media server for organizing and distributing selected media, and/or an ftp server supporting file transfer and/or other types of servers. Other servers are contemplated.

In embodiments, each of the computing devices illustrated in FIG. 1 may be coupled to each other via one or more public or private networks 50. Network 50 may include the Internet, cellular networks, or any other type of known public or private data and/or voice transfer network. In further embodiments, computing devices 82, 84, 86 may be connected to each other by peer-to-peer connections in addition to, or instead of, their connection to network 50.

The service 90 also provides a collection of services which applications running on computing devices 82, 84, 86 may invoke and utilize. For example, computing devices 82, 84, 86 may invoke user login service 94, which is used to authenticate the user 80 seeking access to his or her secure resources from service 90. A user 80 may authenticate him or herself to the service 90 by a variety of authentication protocols, including for example with an ID such as a username and a password.

Where authentication is performed by the service 90, the ID and password may be stored in user account records 98 within a data structure 96. Data structure 96 may further include a rich presence storage location 200 for storing a wide variety of data as explained below. In further embodiments, user account records 98 may be incorporated as part of rich presence storage location 200. While servers 92, login service 94 and data structure 96 are shown as part of a single service 90, some or all of these components may be distributed across different services in further embodiments.

FIG. 2 is an overview of an alternative network topology 60 including a plurality of users and their computing devices in accordance with the present technology. FIG. 2 shows a plurality of users 102, 106, 114, 118, 122, 126 and 132, any one or more of which may be engaged in a social or business relationship with each other. The users shown in FIG. 2 may have associated with them one or more computing devices which may be one or more of the computing devices described above. For example, user 102 has associated with him a notebook computer 104, user 106 has associated with her a gaming console 108, user 118 has associated with her a mobile device 116 and user 122 has associated with him a television 124. Each of the devices illustrated in FIG. 2 may be coupled to each other and cloud services via one or more public or private networks 50 as described above.

In addition to service 90, FIG. 2 further shows cloud-based information 170 which includes public and/or private information about any of the individuals depicted in FIG. 2, and is stored on a network accessible data store which is available via network 50. Public information 170 may for example include a Facebook profile 172, a personal web log 174, a My Space profile 176, geo location presence 178, and/or gaming history 180. Cloud information may further include private data 190 accessible via the cloud, wherein the private data 190 may include things such as purchasing records, banking history, and purchase transaction history via any other number of known vendors. In one embodiment, private data 190 is only accessible based on authorized access by the owner of the private data. Where cloud information 170 and/or private data 190 is used in the present system, this information may be accessed separately from rich presence data store 200, or at least portions of the cloud information 170 and/or private data 190 may be incorporated as part of the rich presence data store 200.

Each of the various types of computing devices shown in FIG. 2 may have the types of data described above for the different computing devices 82, 84, 86. The data for such computing devices may be stored locally and on rich presence data store 200.

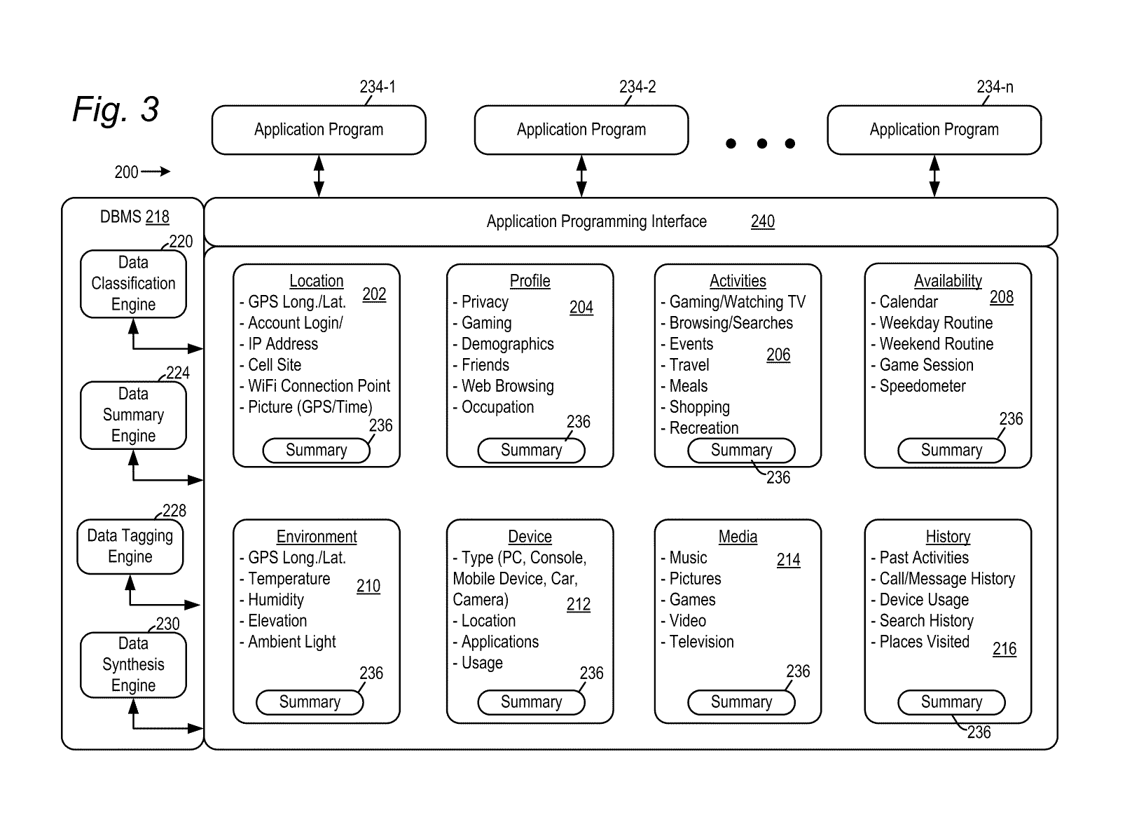

FIG. 3 shows a block diagram of one example of rich presence data store 200. The data store 200 may for example be, or include, a relational database, such as for example an SQL Azure™ Database built on SQL Server® technologies. Other types of databases are contemplated. The data store 200 may include a plurality of classes, classes 202, 204, 206, 208, 210, 212, 214, 216 in this example, each including a different classification of data. Each user may have their own set of classes 202 through 216 for storing data gleaned from his or her own computing devices, such as computing devices 82, 84, 86. Data for a user in data store 200 may come from other sources in further embodiments.

The present system further includes an API 240 which allows the data to be uploaded and accessed as a whole, as explained below. This provides an enhanced view of a user and his experiences, integrated across all of a user's computing devices, referred to herein as rich presence data.

The type of data which may be stored in classes 202 through 216 may be any type of data about a user. The term “user” here is defined broadly to include a user as well as objects and/or entities with which a user interacts. In this context, a user would include people, but may also include a car, a house, a company, etc. It may be gleaned from one, more than one, or all of a user's computing devices, but it may come from sources other than the user's computing devices in further embodiments. By way of example only and without limitation, the classes 202 through 216 into which a user's data may be broken down in FIG. 3 include location data, profile data, a user's activities, a user's availability, a user's environment, devices a user has, media the user has accessed and a user's history.

Location data class 202 may in general include data about a user's current position, and may be given by any of a variety of data extracted from one or more of a user's computing devices. This data may be given by a global positioning service (GPS) receiver in a computing device, such as a mobile telephone 82 carried by a user. Location data may further be given by a user account login at a computing device of known location or by a known IP address. The location data may further come from a cell site picking up a mobile phone, or it may come from a WiFi connection point to which the user is connected, where the location of the WiFi connection point is known. In embodiments, pictures taken by a user may include metadata relating to a time and place when the picture was taken. This information may also be used to identify a user's location in real time when the picture is taken. Other types of location data are contemplated.

The class 204 may have profile data including a user's privacy settings among other information. The present system pushes a large amount of information about users to other users. Each user has the ability to establish privacy settings about how much of their data and personal information is shared. A user may opt-out of sharing their data with others altogether; a user may put in place privacy settings that share their data only with certain users, such as those on their friends list; and a user may setup their privacy settings so that only portions of their data having a privacy rating below a certain threshold are shared. These settings may be manually set by a user through a privacy interface provided by the service 90.

The profile class 204 may further include a variety of other user profile data such as their gaming statistics (gamer profile statistics, games played and purchased, achievements, awards, recorded sessions, etc.); their demographics such as a user's age, family members and contact information; their friends list; browsing and search history; and their occupation information. Other types of profile data are contemplated.

The activities data class 206 in general includes data on what a user is doing in real time. This data may be generated in a variety of direct and indirect ways. Direct methods of gathering such data are provided for example by a console or set top box to show that a user is playing a game or watching TV. Similarly, a user's PC or mobile device may show what browsing and web searches a user is performing A user's device may show that a user has purchased a ticket to an event, or has made certain purchases relating to travel, meals, shopping and other recreational activities (these purchases may occur in real time, or made for some time in the future).

Activities data class 206 may include a variety of other activities that may be directly sensed by their computing devices and uploaded in real time to data store 200. In further embodiments, activities data for class 206 may be obtained indirectly, such as for example by a synthesis engine 230. Synthesis engine 230 is explained in greater detail below, but in general the engine 230 may examine data within the various classes in data store 200 to infer further data, which may then be added to the data store 200. For example, if a user is taking photos, and the photos are recognized as a tourist attraction, the synthesis engine 230 may infer data for activities data class 206 that the user is on vacation and/or sightseeing. Various other types of activity data may be provided in activity data class 206.

The availability data class 208 may show a user's availability in real time. A good source for this information may be a user's calendar as it is updated from any of his or her computing devices and maintained in a central data store (either as part of service 90 or elsewhere). However, other indicators may also be used to establish a user's availability. For example, a user's availability may be inferred from established daily routine on weekdays and weekends through her activities and purchases as detected by her computing devices. Availability may be indicated by what activities a user is performing (as stored in the activities class 206). For example, if a user is in a gaming session, it may be assumed that a user is not then available. Availability data for class 208 may further be inferred indirectly from synthesis engine 230 from other data. For example, if a user's car (or other device) indicates that a user has begun traveling in the car at high speed, and the user's calendar shows that the user has an offsite meeting, the synthesis engine may infer that the user is driving and unavailable for some period of time. Other types of availability data are contemplated.

Environmental data in class 210 may include empirical measurements of a user's surroundings, such as for example current GPS position, temperature, humidity, elevation, ambient light, etc. In the above examples, GPS data is included in location and environment data classes 202 and 210. This shows that at least certain types of data may be included in more than one class.

Device data class 212 may include the types of computing devices a user has and the locations of these devices. Data class 212 may further include the applications loaded on these devices, how often and when these devices are used, and application data. Other types of data may be included in the device data class 212.

Media data class 214 may include any media that the user is then viewing or listening to, or has accessed in the past. This media may include information such as music, pictures, games, video and television. The media data class 214 may include stored copies of this media, or merely a metadata listing of what media the user is or has accessed and, if stored on a user's computing device or storage location, where the media is stored.

History data class 216 may include a historical view of what the user has done in the past. One feature of the present system is the ability to upload user data and make that data available for consumption in real time, as explained in greater detail below. However, historical data may also be stored. Such historical data may include past activities (i.e., data that was stored in activities class 206, but was moved to historical data class 216 once the user was finished with the activity). History data class 216 may include telephone and/or message history (SMS, instant messaging, emails, etc.), and a history of computing device usage and web-browsing/searching. It may further include history of where a user lived, worked, visited, etc. Historical data in class 216 may be only a few seconds or minutes old, or it may be years old.

The above information in classes 202 through 216 is by way of example only. In addition to the data set forth above, data store 200 may further include, without limitation: data from cloud information 170 (FIG. 2) and other social web sites such as Facebook, Four Square, and My Space; service data, such as that which may be available from gaming services such as Xbox LIVE; social graphing data, including friends, friends of friends, family and other socially defined relationships, and exposed data from friends of the user and other levels of the social graph. A wide variety of other data and other data classes may be provided in data store 200.

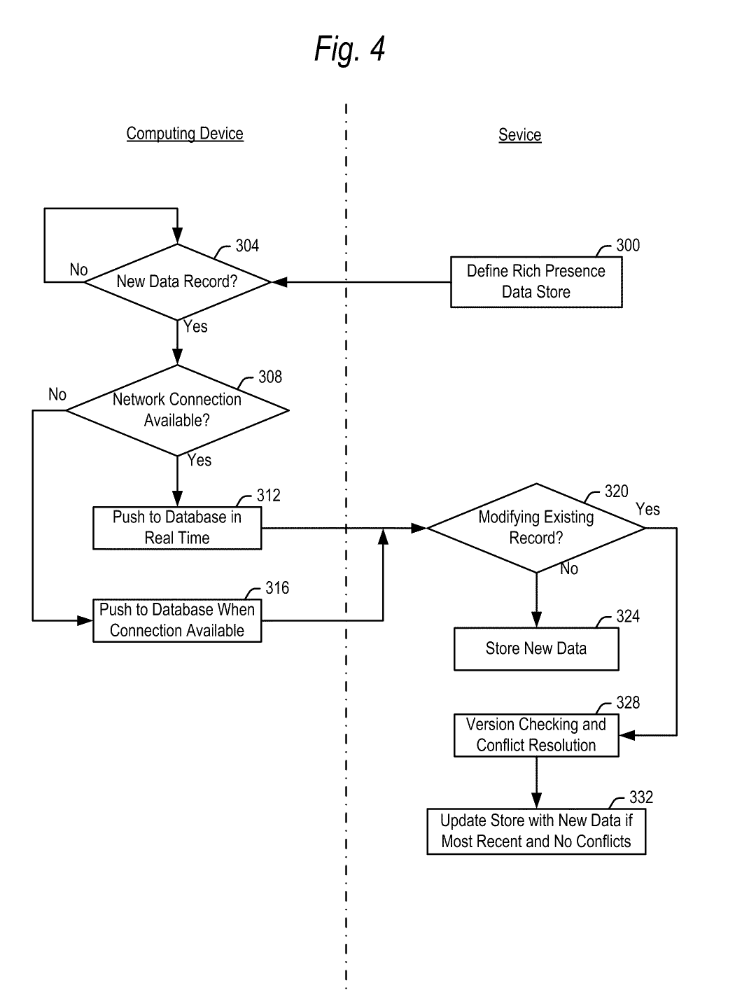

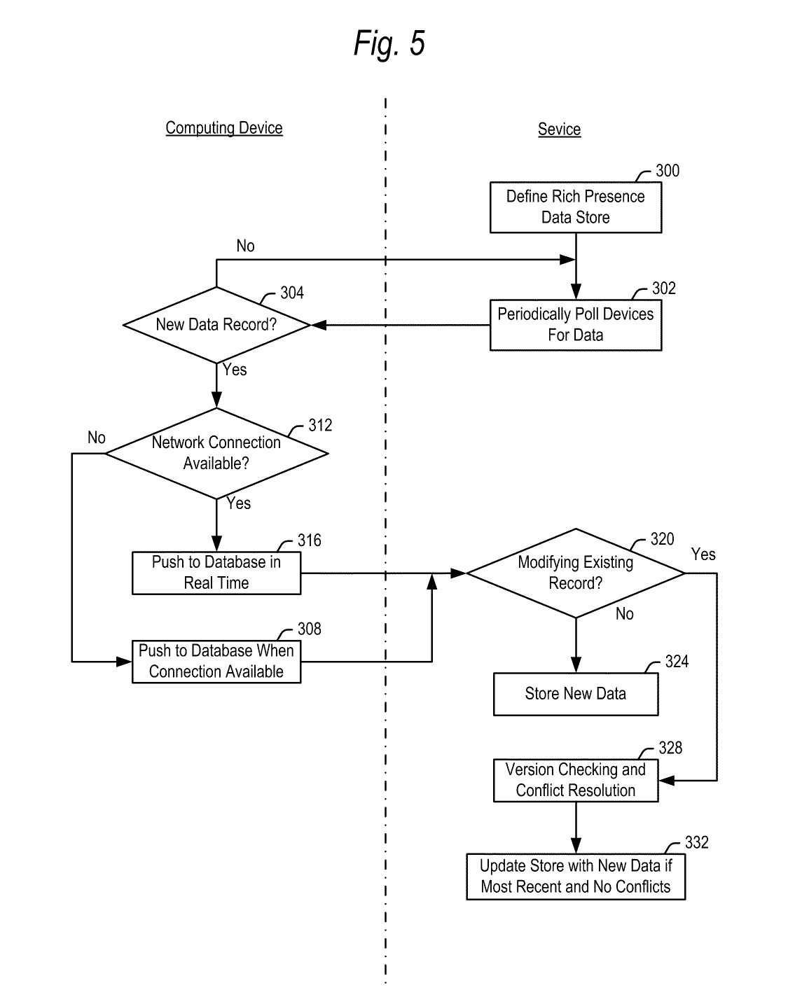

The above-described data may be uploaded from a user's computing devices to the data store 200 in a variety of ways. Two such methods are now described with reference to the flowcharts of FIGS. 4 and 5. In step 300, an administrator may set-up the data store 200 with the aid of a database management service (DBMS) 218, and provides definitions for classes in rich presence data store 200. Such class definitions may additionally or alternatively be generated by a data classification engine 220, the operation of which is explained hereinafter.

In step 304, each computing device checks whether a new data record has been created locally within the device. If so, the computing device checks whether it has a connection to data store 200 in step 308. If so, the new data record is pushed to the data store in step 312. In this way, new data may be uploaded to the data store in real time. This allows processing of the data as explained below so that it may be accessed in real time as well. However, if no network connection is available in step 308, the data is uploaded to the data store 200 in step 316 when the connection becomes available.

Data uploaded to the data store 200 may already have versions of the same data from prior measurements already on data store 200. In step 320, the DBMS 218 may check whether the received data is attempting to modify an existing record already stored in data store 200. If no prior versions of the received data are found on the data store, the new data is stored in step 324. If a version of the data already exists, then DBMS 218 may perform known version checking and conflict resolution on the current and earlier versions of the data in step 328. If the new data is found to be the most recent version and any conflicts are resolved, the data may be stored in step 332. If a conflict is found which is not resolvable upon application of stored conflict rules, a user may be prompted to resolve the conflict as is known.

The above describes a method where new data is pushed up to the store 200 from various computing devices of a user. FIG. 5 shows an alternative embodiment where service 90 pulls the data from each of a user's computing devices. Each of the steps in FIG. 5 having a like reference number to FIG. 4 are operationally the same and the above description is incorporated here. One difference is that in the example of FIG. 5, the service 90 periodically polls computing devices belonging to a user in step 302. If a new record is found in step 304, the data is uploaded as previously described. If no new data records are found, the service 90 performs the polling again at the next polling interval. The polling interval may be set to be short, for example a few seconds, to allow data upload in real time or near to real time. The polling interval may be longer or shorter than a few seconds in further embodiments.

The upload of data from a user's computing devices as described above in FIGS. 4 and 5 may occur for each of a user's computing devices, and for each user associated with the service 90. Thus, the data store 200 has rich presence data for a user, as well as a user's friends and others which the user may also discover as explained below. It is further understood that data from a user's computing device may be uploaded to the cloud in a variety of ways and using a variety of steps in addition to or instead of those described above with respect to FIGS. 4 and 5.

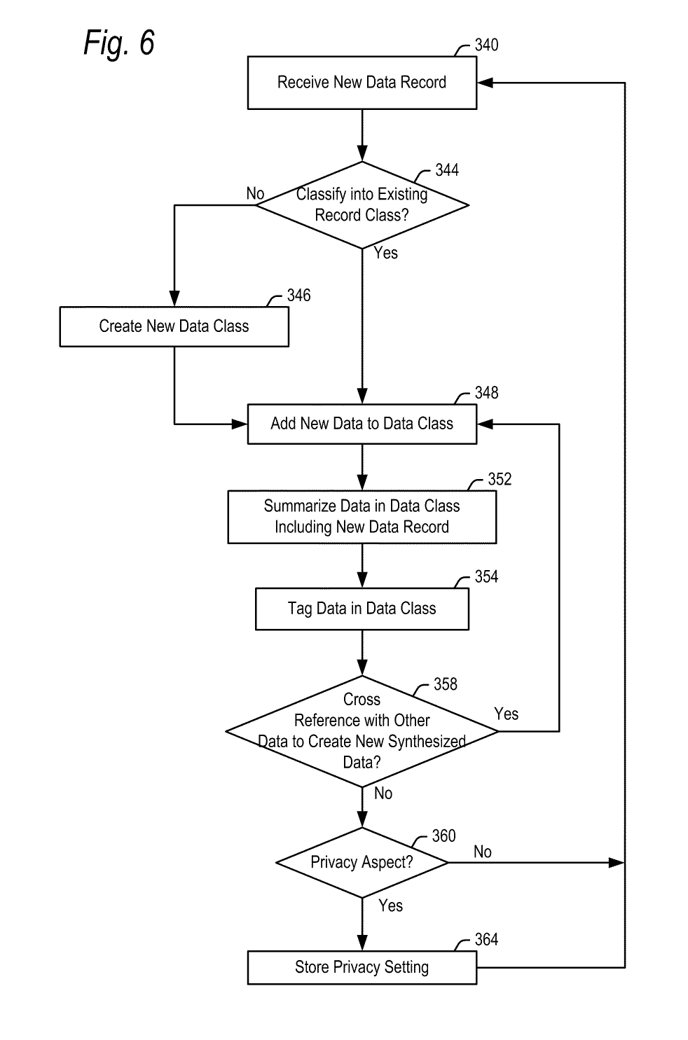

Once data is uploaded to the data store 200, various processing operations may be performed on the data under the control of DBMS 218 as shown in FIG. 3. DBMS 218 is disclosed by way of an example only. It is understood that the processing operations described below may be performed by control algorithms other than a DBMS in further embodiments. Whether performed by DBMS 218 or some other control, these processing steps may include one or more of classifying the data into classes, summarizing the data, tagging the data and checking whether new data may be synthesized from the detected data. These operations are explained below with reference again to FIG. 3 and the flowchart of FIG. 6.

In step 340, new data from a user computing device is received. In step 344, the data classification engine 220 checks whether the received data may be classified into an existing data class. The data classification engine 220 may be a known component of the DBMS 218 for setting up fields, a set of relations for each field, and a definition of queries which may be used to access the data associated with the different fields and relational sets. Given a set of predefined constraints, the data classification engine 220 is able to sort received data into the different classes, as well as detecting when a new class is needed for new data. Classification engine 220 may use known methods to sort data into classes and/or create new classes. A database administrator may also monitor the data store 200 and facilitate the operation of the data classification engine 220 to classify data and determine when new data classes are needed.

If the data classification engine 220 determines that new data fits within a defined class, that data is added to that class in step 348. If the engine 220 determines that new data necessitates a new data class, the engine may create that new class in step 346, and the new data may be added to that new data class in step 348.

In step 352, the data for a given data class may be summarized by a data summarization engine 224. In particular, when new data is received, it may have some indicator of the reliability of that data, such as for example a confidence value. The reliability indicator may for example be based on the known accuracy of the source, and whether the data was measured directly by a computing device or inferred from the synthesis engine explained below. A variety of other factors may go into determining the confidence value for a reliability indicator. A reliability indicator may remain as a constant, or it may decay over time. For example, location data is best in real time, but is less reliable as the location data grows older.

In one embodiment, the summarization engine 224 analyzes the reliability indicators for each data record in a class, and determines a summary 236 having an optimal data value representative of the class of data values. It may be based on a determination that reliability indicators show that one data value is more reliable than the other data values. For example, GPS data may be more reliable than an IP address for giving a user's location. In such embodiments, the summarization engine 224 may return a summary 236 having the data associated with the highest reliability indicator. In further embodiments, the summarization engine 224 may return a summary 236 having a composite value based on several reliability indicators. The summarization engine 224 may return a variety of other factors, including overall reliability of the data, median values and standard deviations.

As an example of the operation of the summarization engine 224, the data store may have multiple location data inputs (GPS latitude/longitude, WiFi node, etc.). The reliability indicator for these data values may include information such as the signal strength of the GPS signal, and the range of the WiFi network. Using the reliability indicators, the summarization engine 224 may determine to use one data point and discard the other. Alternatively, the summarization engine may use more than one data point to create a summary 236 having a composite location with a single summary value (e.g., latitude/longitude) or multiple data points (e.g., latitude/longitude plus an overall reliability score).

In step 354, a data tagging engine 228 may be used to provide a metadata tag on at least certain items of data. In particular, data items in a class may be tagged with descriptors for use in any of a variety of ways to facilitate use of that data across a variety of computing devices, application programs and scenarios. Some computing devices may need that data formatted in a specific way, which information may be provided in a metadata tag. Some application programs may use the data in one way, while other programs use the data in another way, which information may be provided in a metadata tag.

The metadata tags may be generated by the data tagging engine 228 and associated with a particular item of data. The data tagging engine 228 may generate the tags based on predefined rules as to how and when data is to be tagged, which information may be provided by DBMS 218. Alternatively or additionally, the tagging engine 228 may make use of metadata uploaded with an item of data.

The synthesis engine 230 next checks in step 358 whether items of data within the data store 200 may be used individually, or cross-referenced against other items of data, to synthesize new data. In particular, an administrator may create rules stored in the DBMS 218 which define when logical inferences may be drawn from specific data types to create new items of data. A few examples have been set forth above: use of a car's speed data together with calendar appointment data may be used to infer data regarding a user's availability; recognition of the subject of a user's photographs (for example by known photo recognition techniques) may be used to infer new data that the user is on vacation and/or sightseeing. A wide variety of other predefined rules may be provided to define when logical inferences may be made about data in data store 200 by the synthesis engine 230 to deduce new data.

The data in store 200 may be processed by one or more of the engines 220, 224, 228 and 230 as described above. It is understood that one or more of these processing steps may be omitted in alternative embodiments.

Either before or after the above-described processing steps, the system may check in step 360 whether received data has some privacy aspect associated with it by the user or by the DBMS 218. Each user has the ability to establish privacy settings about an item of data, specifying if, and by whom, the data may be viewed. A user may associate a specific set of privacy rules with each item of data setting forth in detail the privacy settings that are to be associated with that item of data. Alternatively, a user may simply assign a general privacy rating to an item of data. This general rating may then be used by the DBMS 218 to set up a privacy hierarchy of the data. With this hierarchy, a user may specify a threshold privacy setting, for example in their profile data. In so doing, the user agrees to allow access to all data with a privacy rating below (or above) the specified threshold setting. This allows a user to apply privacy settings to a broad range of data quickly and easily. The user may also easily change the privacy settings for a broad range of data in this manner.

In step 360, the DBMS 218 may check whether a new piece of data has an associated privacy setting, such as for example a detailed rule and/or a general rating. If so, the privacy setting may be stored as described above in the profile class 204 in step 364.

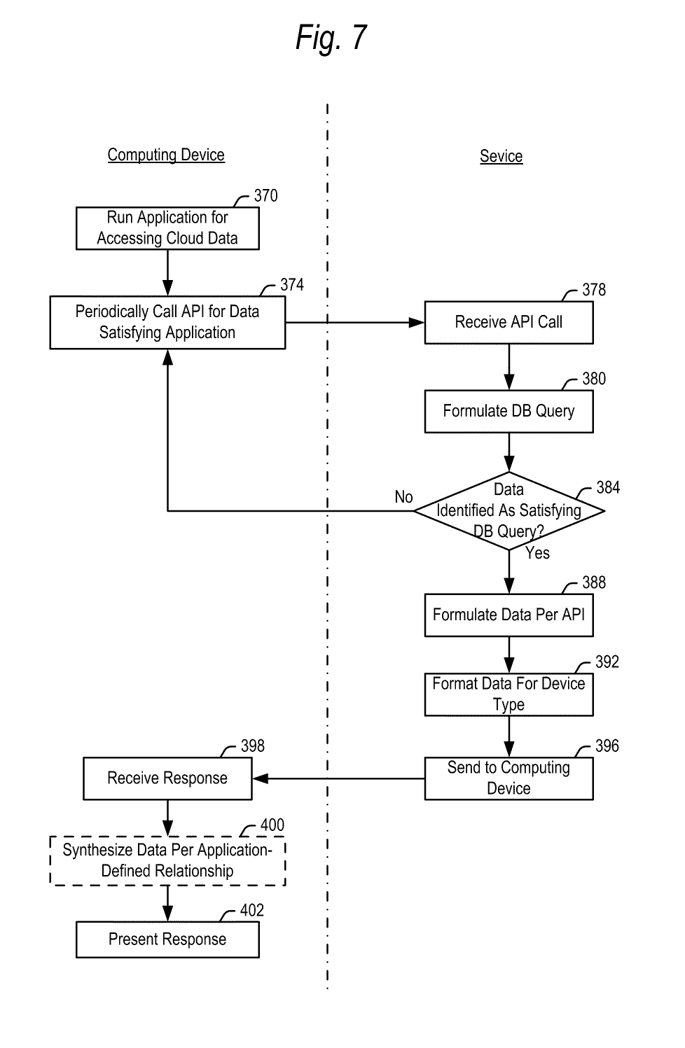

Once the data has been uploaded, processed and organized, it is available for access by one or more application programs. An embodiment of this process is now described with reference to FIG. 3 and the flowchart of FIG. 7. In step 370, a user may execute an application program from one of their computing devices, such as for example one or more of the application programs 234-1, 234-2, . . . , 234-n. Any one of these application programs may cause the computing device to periodically call an API 240 for accessing data store 200.

In accordance with the present technology a single, generalized API 240 may be used to expose the full range of a user's data in store 200, across all data classes and for all device types, to the accessing application program. In particular, the API is able to formulate a query, based on the objectives of the accessing application program, to search the sum-total of a user's data and data classes, for all fields which satisfy the query.

As noted above, conventional systems may have provided multiple APIs which allow a view into disjointed segments of user data. However, conventional APIs did not provide access to the full scope of rich presence data stored in data store 200. The operation of API 240 to expose the full range of data and data classes allows a clearer picture and enhanced experiences relative to what was accessible through conventional and/or disparate APIs. For example, the present system allows a user to interact seamlessly with his various computing devices, to have them act in concert instead of as discrete processing devices. Moreover, the present system allows a user to discover and interact with other users in a way that is not known with conventional systems. Some examples are explained in greater detail below.

Referring again to the flowchart of FIG. 7, once an application program 234 makes an API call in step 370, the API 240 receives the call in step 378 and formulates an object-based query in step 380 to search across all classes for data that satisfies the call. In step 384, the DBMS 218 may retrieve the data fields responsive to the query. In step 388, the retrieved data fields may be formulated into a response for forwarding to the computing device. Different devices have different capabilities, and the response data may be formatted for the particular accessing device in step 392 (or formatting instructions may be forwarded with the response). The response is then sent to the computing device in step 396 and received in the device in step 398.

As noted above, the synthesis engine 230 may synthesize data stored in data store 200. It may happen that the application program 234 queries the data store 200 for disparate pieces of data, and then performs a synthesis step which is separate than the operation performed by the synthesis engine 230. If so, the separate synthesis step on the returned data may be processed by the application program 234 in step 400. Step 400 is shown in dashed lines as it is optional and may be omitted. The formulated response may be presented over the receiving computing device in step 402. It is noted here that “presenting” the response may mean a visual or audible response over the receiving computing device. It may also mean executing a program on the computing device, or performing some other action on the computing device.

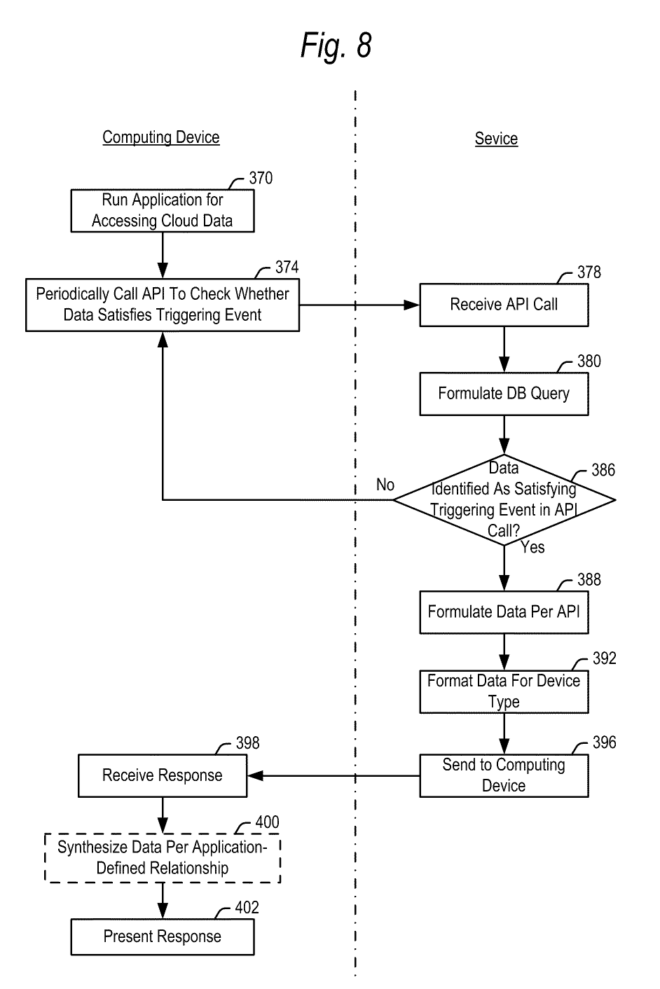

FIG. 8 shows an alternative embodiment for accessing data via API 240. FIG. 8 is similar to FIG. 7, with the modification that the call to the API 240 is made in step 374 to look for some triggering event that has occurred in the uploaded data. The triggering event may be defined by the application program 234, another application running on a computing device and/or a user of a device. Triggering events can be any of a wide variety of conditional events which are detected by one or more computing devices and uploaded to the data store 200. Triggering events can be proximity related, for example:
if computing device x is within y feet of computing device z, formulate response as specified in the application program 234.
   Triggering events may alternatively, or additionally, be temporal:
if within v hours of calendar event w [and computing device x is within y yards of computing device z], formulate response. Any of a wide variety of other examples are contemplated. While proximity and temporal triggering events are good examples, the triggering event need not be related to proximity or temporal events in further embodiments. The computing device making the API call may or may not be the one or more computing devices which sensed the triggering event.

The trigger event can also be determined in the cloud, not just on computing devices. For example a single device may not know a total number of pictures uploaded by all devices, but once total number of pictures in cloud reaches a threshold then the event triggers. For example, FIG. 8 shows a step 386 where the service 90 determines whether data stored in the data store satisfies a triggering event in an API call. If so, steps 388 through 402 proceed as described above with respect to the flowchart of FIG. 7.

The API 240 described above is used to expose the data across the sum-total of all data classes to any of a plurality of program applications running on a computing device. It is understood that the same or similar API may be used to upload the data to the data store 200 and present the data to the DBMS 218 for processing and storing as described above.

As noted, the present technology may be used to enhance a user's experience and interaction with their own computing devices and/or with other users. The following is an example of a user, for example user 80 in FIG. 1, enhancing the interactivity with their own computing devices 82, 84, 86. In this example, the degree of knowledge and interactivity made possible from the rich presence data via API 240 allows seamless handoff of applications between computing devices, an operation also referred to as a dissolve/evolve model of user interaction with their devices. In particular, a user may be running an application on their mobile device 82. An application program 234 may be running in the background which provides real time knowledge of a user's location, as well as proximity to a user's other devices, such as for example their console. The application program 234, the foreground application running on mobile device 82, or the user may have set up a triggering event which says:
when mobile computing device w is running application x and is within y feet of console computing device z, start console computing device, run application x, link to specific instance of game running on computing device z, and obtain state data of specific instance of game running on computing device z.

Thus, for example when the user is on his way home, running gaming application x, when he gets close to his house, his console will start up, and join the game he is playing so that he can handoff from playing on his computing device to his console.

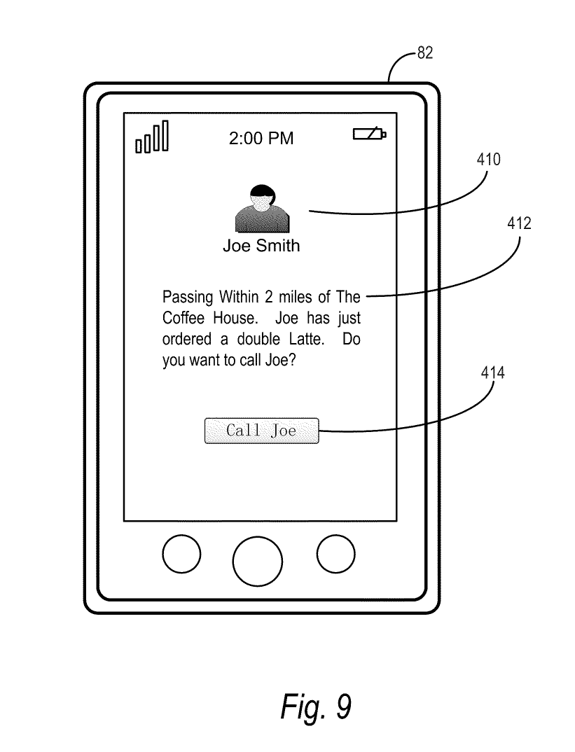

Another example is explained below with reference to FIG. 9. In this example, a user is able to access real time data across a variety of data classes in data store 200 to enhance his social interaction with others. Here, a user has set up a triggering event (or has run an application program 234 including this triggering event) which says:
when user x mobile computing device is within 2 miles of The Coffee House, check for any detected devices at The Coffee House on user x Friends List; if found, sound alert, display detected friend contact info, message y and present call button.

Note in this example, the specified function of the API call is not only to perform a specific result, but also to check the status of other data in data store 200. Namely, upon the triggering event, check the data store to look for friends at a specific location. Here, when user x passed within 2 miles of The Coffee House, the API call resulted in detection of Joe Smith's device, a friend of user x. Joe's activity class data indicates that Joe just ordered a double latte (indicated for example from a sales receipt). This information was uploaded to Joe's data on data store 200. Joe has permissions set that allow his friends to discover this data. As such, when the user is passing within 2 miles of The Coffee House, the user's device triggers the API call, which identifies that Joe is there, what Joe is doing, and offers the user the option to join Joe. The user's mobile device may sound an alert, present Joe's contact information 410, present a message 412 including information identified in the API call, and give the user a button 414 to get in touch with their friend.

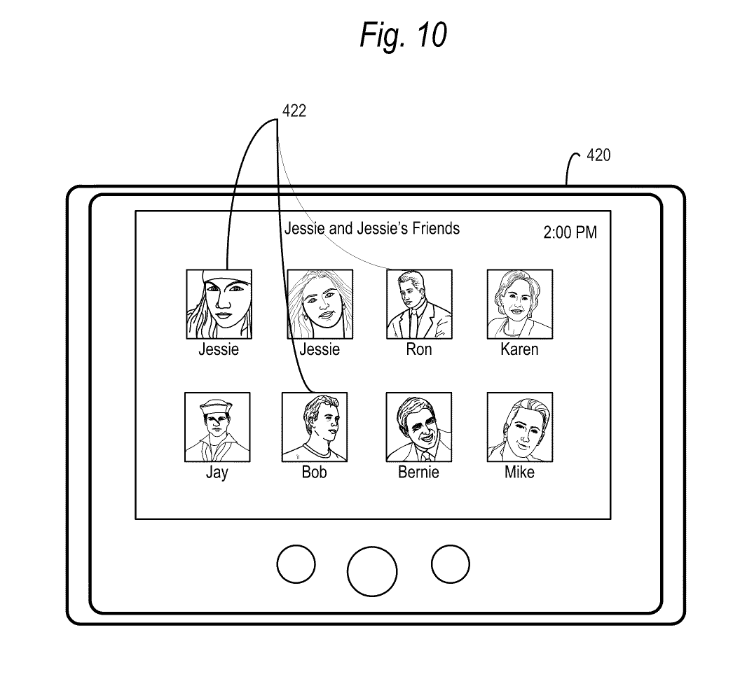

FIG. 10 is another example, where the present technology enhances a user's interaction with her own devices and with a friend. In this example, a user has set up a triggering event (or runs a program application 234 setting up the triggering event) which says:
If a friend on user x's Friend List passes within 10 feet of user x tablet computing device y, identify all pictures with found friend, and friends of found friend, and display if privacy setting for identified picture is below z.

In this example, a tablet computing device 420 detected a computing device of Jessie, who is on the user's friends list. The tablet 420 retrieved all available pictures 422 of Jessie and her friends, and displayed those pictures having a privacy rating (set by Jessie or the user) below some arbitrarily defined value z.

It is noted that once the API call is made through the network 50 to service 90, so that some action is initiated, that action may take place by direct communication methods, such as Bluetooth, RF, IR and Near Field communications. Thus, in the example of FIG. 10, the tablet 420 may retrieve pictures from a storage location in the tablet, from the data store 200, or from other computing devices with which the tablet can establish a direct communications link.

FIG. 11 illustrates an example of a suitable general computing system environment 500 that may comprise for example the desktop or laptop computing device 84. The computing system environment 500 is only one example of a suitable computing environment and is not intended to suggest any limitation as to the scope of use or functionality of the inventive system. Neither should the computing system environment 500 be interpreted as having any dependency or requirement relating to any one or combination of components illustrated in the exemplary computing system environment 500.

The inventive system is operational with numerous other general purpose or special purpose computing systems, environments or configurations. Examples of well known computing systems, environments and/or configurations that may be suitable for use with the present system include, but are not limited to, personal computers, server computers, multiprocessor systems, microprocessor-based systems, set top boxes, programmable consumer electronics, network PCs, minicomputers, mainframe computers, laptop and palm computers, hand held devices, distributed computing environments that include any of the above systems or devices, and the like.

With reference to FIG. 11, an exemplary system for implementing the present technology includes a general purpose computing device in the form of a computer 510. Components of computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 510 may include a variety of computer readable media. Computer readable media can be any available media that can be accessed by computer 510 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, random access memory (RAM), read only memory (ROM), EEPROM, flash memory or other memory technology, CD-ROMs, digital versatile discs (DVDs) or other optical disc storage, magnetic cassettes, magnetic tapes, magnetic disc storage or other magnetic storage devices, or any other medium which can be used to store the desired information and which can be accessed by computer 510. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 530 includes computer storage media in the form of volatile and/or nonvolatile memory such as ROM 531 and RAM 532. A basic input/output system (BIOS) 533, containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 11 illustrates operating system 534, application programs 535, other program modules 536, and program data 537.

The computer 510 may also include other removable/non-removable, volatile/nonvolatile computer storage media. By way of example only, FIG. 11 illustrates a hard disc drive 541 that reads from or writes to non-removable, nonvolatile magnetic media and a magnetic disc drive 551 that reads from or writes to a removable, nonvolatile magnetic disc 552. Computer 510 may further include an optical media reading device 555 to read and/or write to an optical media.

Other removable/non-removable, volatile/nonvolatile computer storage media that can be used in the exemplary operating environment include, but are not limited to, magnetic tape cassettes, flash memory cards, DVDs, digital video tapes, solid state RAM, solid state ROM, and the like. The hard disc drive 541 is typically connected to the system bus 521 through a non-removable memory interface such as interface 540, magnetic disc drive 551 and optical media reading device 555 are typically connected to the system bus 521 by a removable memory interface, such as interface 550.

The drives and their associated computer storage media discussed above and illustrated in FIG. 11, provide storage of computer readable instructions, data structures, program modules and other data for the computer 510. In FIG. 11, for example, hard disc drive 541 is illustrated as storing operating system 544, application programs 545, other program modules 546, and program data 547. These components can either be the same as or different from operating system 534, application programs 535, other program modules 536, and program data 537. Operating system 544, application programs 545, other program modules 546, and program data 547 are given different numbers here to illustrate that, at a minimum, they are different copies. A user may enter commands and information into the computer 510 through input devices such as a keyboard 562 and a pointing device 561, commonly referred to as a mouse, trackball or touch pad. Other input devices (not shown) may include a microphone, joystick, game pad, satellite dish, scanner, or the like. These and other input devices are often connected to the processing unit 520 through a user input interface 560 that is coupled to the system bus 521, but may be connected by other interface and bus structures, such as a parallel port, game port or a universal serial bus (USB). A monitor 591 or other type of display device is also connected to the system bus 521 via an interface, such as a video interface 590. In addition to the monitor, computers may also include other peripheral output devices such as speakers 597 and printer 596, which may be connected through an output peripheral interface 595.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 11. The logical connections depicted in FIG. 11 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communication over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in the remote memory storage device. By way of example, and not limitation, FIG. 11 illustrates remote application programs 585 as residing on memory device 581. It will be appreciated that the network connections shown are exemplary and other means of establishing a communication link between the computers may be used.

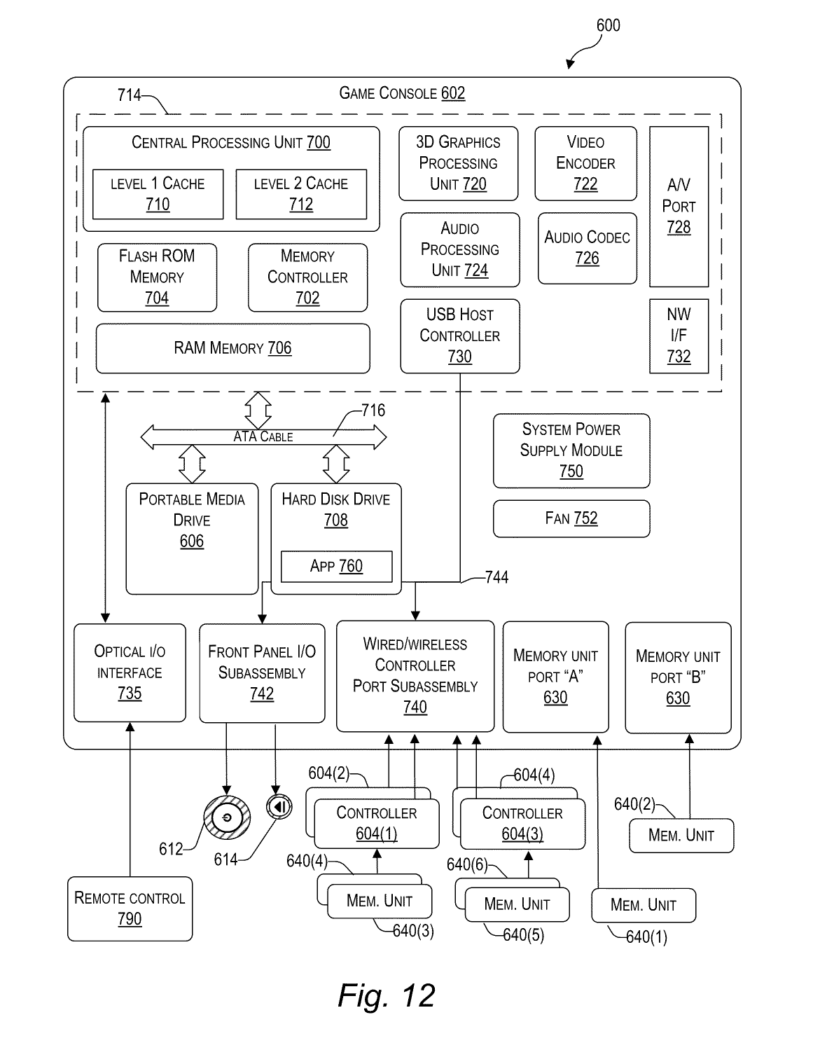

FIG. 12 is a functional block diagram of gaming and media system 600, and shows functional components of gaming and media system 600 in more detail. System 600 may be the same as the computing device 86 described above. Console 602 has a central processing unit (CPU) 700, and a memory controller 702 that facilitates processor access to various types of memory, including a flash Read Only Memory (ROM) 704, a Random Access Memory (RAM) 706, a hard disk drive 708, and portable media drive 606. In one implementation, CPU 700 includes a level 1 cache 710 and a level 2 cache 712, to temporarily store data and hence reduce the number of memory access cycles made to the hard drive 708, thereby improving processing speed and throughput.

CPU 700, memory controller 702, and various memory devices are interconnected via one or more buses (not shown). The details of the bus that is used in this implementation are not particularly relevant to understanding the subject matter of interest being discussed herein. However, it will be understood that such a bus might include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, CPU 700, memory controller 702, ROM 704, and RAM 706 are integrated onto a common module 714. In this implementation, ROM 704 is configured as a flash ROM that is connected to memory controller 702 via a PCI bus and a ROM bus (neither of which are shown). RAM 706 is configured as multiple Double Data Rate Synchronous Dynamic RAM (DDR SDRAM) modules that are independently controlled by memory controller 702 via separate buses (not shown). Hard disk drive 708 and portable media drive 606 are shown connected to the memory controller 702 via the PCI bus and an AT Attachment (ATA) bus 716. However, in other implementations, dedicated data bus structures of different types can also be applied in the alternative.

A three-dimensional graphics processing unit 720 and a video encoder 722 form a video processing pipeline for high speed and high resolution (e.g., High Definition) graphics processing. Data are carried from graphics processing unit 720 to video encoder 722 via a digital video bus (not shown). An audio processing unit 724 and an audio codec (coder/decoder) 726 form a corresponding audio processing pipeline for multi-channel audio processing of various digital audio formats. Audio data are carried between audio processing unit 724 and audio codec 726 via a communication link (not shown). The video and audio processing pipelines output data to an A/V (audio/video) port 728 for transmission to a television or other display. In the illustrated implementation, video and audio processing components 720-728 are mounted on module 714.

FIG. 12 shows module 714 including a USB host controller 730 and a network interface 732. USB host controller 730 is shown in communication with CPU 700 and memory controller 702 via a bus (e.g., PCI bus) and serves as host for peripheral controllers 604(1)-604(4). Network interface 732 provides access to a network (e.g., Internet, home network, etc.) and may be any of a wide variety of various wired or wireless interface components including an Ethernet card, a modem, a wireless access card, a Bluetooth module, a cable modem, and the like.

In the implementation depicted in FIG. 12, console 602 includes a controller support subassembly 740 for supporting four controllers 604(1)-604(4). The controller support subassembly 740 includes any hardware and software components needed to support wired and wireless operation with an external control device, such as for example, a media and game controller. A front panel I/O subassembly 742 supports the multiple functionalities of power button 612, the eject button 614, as well as any LEDs (light emitting diodes) or other indicators exposed on the outer surface of console 602. Subassemblies 740 and 742 are in communication with module 714 via one or more cable assemblies 744. In other implementations, console 602 can include additional controller subassemblies. The illustrated implementation also shows an optical I/O interface 735 that is configured to send and receive signals that can be communicated to module 714.

MUs 640(1) and 640(2) are illustrated as being connectable to MU ports “A” 630(1) and “B” 630(2) respectively. Additional MUs (e.g., MUs 640(3)-640(6)) are illustrated as being connectable to controllers 604(1) and 604(3), i.e., two MUs for each controller. Controllers 604(2) and 604(4) can also be configured to receive MUs (not shown). Each MU 640 offers additional storage on which games, game parameters, and other data may be stored. In some implementations, the other data can include any of a digital game component, an executable gaming application, an instruction set for expanding a gaming application, and a media file. When inserted into console 602 or a controller, MU 640 can be accessed by memory controller 702.

A system power supply module 750 provides power to the components of gaming and media system 600. A fan 752 cools the circuitry within console 602.

An application 760 comprising machine instructions is stored on hard disk drive 708. When console 602 is powered on, various portions of application 760 are loaded into RAM 706, and/or caches 710 and 712, for execution on CPU 700, wherein application 760 is one such example. Various applications can be stored on hard disk drive 708 for execution on CPU 700.

Gaming and media system 600 may be operated as a standalone system by simply connecting the system to monitor 88 (FIG. 1), a television, a video projector, or other display device. In this standalone mode, gaming and media system 600 enables one or more players to play games, or enjoy digital media, e.g., by watching movies, or listening to music. However, with the integration of broadband connectivity made available through network interface 732, gaming and media system 600 may further be operated as a participant in a larger network gaming community.

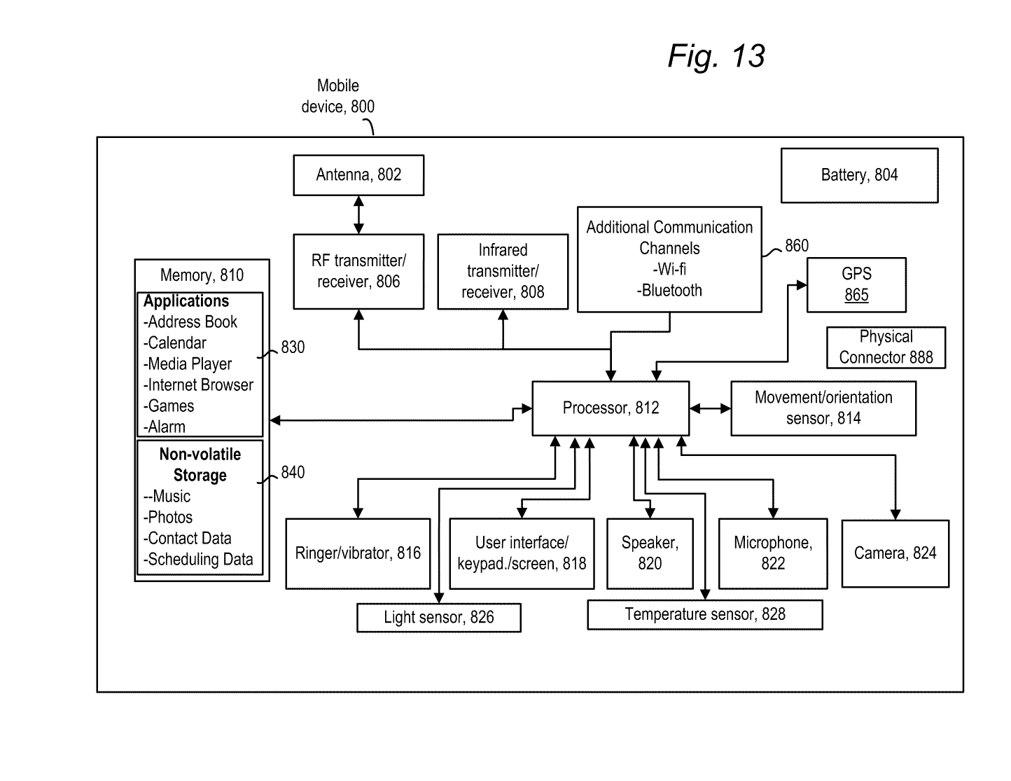

FIG. 13 depicts an example block diagram of a mobile device. Exemplary electronic circuitry of a typical m phone is depicted. The phone 800 includes one or more microprocessors 812, and memory 810 (e.g., non-volatile memory such as ROM and volatile memory such as RAM) which stores processor-readable code which is executed by one or more processors of the control processor 812 to implement the functionality described herein.

Mobile device 800 may include, for example, processors 812, memory 810 including applications and non-volatile storage. The processor 812 can implement communications, as well as any number of applications, including the interaction applications discussed herein. Memory 810 can be any variety of memory storage media types, including non-volatile and volatile memory. A device operating system handles the different operations of the mobile device 800 and may contain user interfaces for operations, such as placing and receiving phone calls, text messaging, checking voicemail, and the like. The applications 830 can be any assortment of programs, such as a camera application for photos and/or videos, an address book, a calendar application, a media player, an internet browser, games, an alarm application, other third party applications, the interaction application discussed herein, and the like. The non-volatile storage component 840 in memory 810 contains data such as web caches, music, photos, contact data, scheduling data, and other files.

The processor 812 also communicates with RF transmit/receive circuitry 806 which in turn is coupled to an antenna 802, with an infrared transmitted/receiver 808, and with a movement/orientation sensor 814 such as an accelerometer. Accelerometers have been incorporated into mobile devices to enable such applications as intelligent user interfaces that let users input commands through gestures, indoor GPS functionality which calculates the movement and direction of the device after contact is broken with a GPS satellite, and to detect the orientation of the device and automatically change the display from portrait to landscape when the phone is rotated. An accelerometer can be provided, e.g., by a micro-electromechanical system (MEMS) which is a tiny mechanical device (of micrometer dimensions) built onto a semiconductor chip. Acceleration direction, as well as orientation, vibration and shock can be sensed. The processor 812 further communicates with a ringer/vibrator 816, a user interface keypad/screen 818, a speaker 820, a microphone 822, a camera 824, a light sensor 826 and a temperature sensor 828.

The processor 812 controls transmission and reception of wireless signals. During a transmission mode, the processor 812 provides a voice signal from microphone 822, or other data signal, to the transmit/receive circuitry 806. The transmit/receive circuitry 806 transmits the signal to a remote station (e.g., a fixed station, operator, other cellular phones, etc.) for communication through the antenna 802. The ringer/vibrator 816 is used to signal an incoming call, text message, calendar reminder, alarm clock reminder, or other notification to the user. During a receiving mode, the transmit/receive circuitry 806 receives a voice or other data signal from a remote station through the antenna 802. A received voice signal is provided to the speaker 820 while other received data signals are also processed appropriately.

Additionally, a physical connector 888 can be used to connect the mobile device 800 to an external power source, such as an AC adapter or powered docking station. The physical connector 888 can also be used as a data connection to a computing device. The data connection allows for operations such as synchronizing mobile device data with the computing data on another device.

A GPS receiver 865 utilizing satellite-based radio navigation to relay the position of the user applications is enabled for such service.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method of organizing and allowing access to cloud data, comprising:
a) detecting data of a user via one or more computing devices, the detected data including at least one of:
a1) a location of the user,
a2) an activity of the user,
a3) a profile of the user,
a4) a device of the user,
a5) an environment of the user,
a6) availability of the user;
b) aggregating the data detected in said step a) in a data store; and
c) exposing the data aggregated in the data store in said step b) to an application program via a single application programming interface for access by a plurality of applications.

2. The method of claim 1, further comprising the step d) of processing the data aggregated in the data store by categorizing the data detected in said step a) into classes and summarizing the data within the different classes.

3. The method of claim 2, said step of summarizing the data comprising the step of analyzing reliability indicators associated with the data aggregated in said step b, and determining a summary for the class, the summary including an optimal data value based on the analysis of the reliability indicators.

4. The method of claim 2, said step d) of processing the data further comprising the step of synthesizing the first item of data to obtain a second item of data resulting from a logical inference about the first item of data.

5. The method of claim 1, said step c) of exposing the data aggregated in the data store to an application program comprising the step of exposing the data to a plurality of computing devices including at least a mobile telephone, a personal computer and gaming console via a single application programming interface.

6. The method of claim 1, the user comprising a first user, the method further comprising the steps of:
e) detecting data of a second user via one or more computing devices, the detected data including at least a location of the user and an activity of the user;
f) aggregating the data detected in said step a) in a data store; and
g) exposing the data aggregated in the data store in said steps b) and f) to an application program via a single application programming interface.

7. The method of claim 1, further comprising the step h) of exposing the data to the application program via the single application programming interface upon occurrence of a conditional trigger event.

8. The method of claim 7, further comprising the step j) aggregating data in the data store indicating the occurrence of the conditional trigger event prior to said step h).

9. A computer-readable storage medium for programming a processor to perform a method of organizing and allowing access to cloud data, the method comprising:
a) detecting data of a user via one or more computing devices, the detected data including at least two of:
a1) a location of the user,
a2) an activity of the user,
a3) a profile of the user,
a4) a device of the user,
a5) an environment of the user,
a6) availability of the user;
b) aggregating the data detected in said step a) in a data store, the location data being stored in a first data class, the activity data being stored in a second data class, the profile data being stored in a third data class and the device data being stored in a fourth data class;
c) summarizing the data in each of the first, second, third and fourth data classes to arrive at at least one representative item of data for each of the first, second, third and fourth data classes; and
d) exposing the data aggregated in the data store in said step b) to an application program via a single application programming interface.

10. The computer-readable media of claim 9, said step a) of detecting data and said step b) of aggregating the data occurring in real time.

11. The computer-readable media of claim 9, further comprising the step e) of receiving privacy settings indicating whether and under what conditions the user agrees to share the data aggregated in said step b) with other users.

12. The computer-readable media of claim 11, said step e) comprising the step of a user associating a privacy rankings with data items of the data aggregated in said step b), and the user setting a privacy threshold to be applied to data having a privacy ranking.

13. The computer-readable media of claim 9, further comprising the step f) of synthesizing the first item of data to obtain a second item of data resulting from a logical inference about the first item of data.

14. The computer-readable media of claim 9, the user comprising a first user, the method further comprising the steps of:
g) detecting data of a second user via one or more computing devices, the detected data including at least a location of the user and an activity of the user;
h) aggregating the data detected in said step a) in a data store; and
j) exposing the data aggregated in the data store in said steps b) and h) to an application program via a single application programming interface.

15. The computer-readable media of claim 14, further comprising the step of the first user discovering an activity of the second user in real time and the first user joining the second user in the activity.

16. A method of organizing and allowing access to cloud data, the method comprising:
a) detecting data of a user via one or more computing devices relating at least to where a user is and what a user is doing;
b) aggregating the data detected in said step a) in a data store;
c) defining a trigger event, the trigger event relating to occurrence of a condition measured by the one or more computing devices;
d) determining whether data indicating that the trigger event has occurred is aggregated to the data store; and
e) exposing the data aggregated in the data store in said step b) to an application program via a single application programming interface upon a determination in said step d) that data indicating that the trigger event has occurred has been aggregated to the data store.

17. The method of claim 16, said step c) of defining a trigger event comprising the step of defining the trigger event to relate to at least one of a proximity of one or more computing devices to another location and a temporal event.

18. The method of claim 16, said step b) of aggregating the data detected in said step a) occurring in real time with the detection of the data in said step a).

19. The method of claim 16, further comprising the step f) of detecting a sum-total of data from all interactions of a user with their computing devices and the step g) of aggregating that sum-total of data to the data store.

20. The method of claim 19, further comprising the steps of exposing the data aggregated in the data store in said step g) to an application program via a single application programming interface.
